(19) United States
(12) Patent Application Publication
(10) Pub. No.: US 2003/0191973 A1
(43) Pub. Date: Oct. 9, 2003

(54) Temporary user suspension of automatic shutdown

(76) Inventor: Carolynn Rae Johnson, Indianapolis, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/116,574

(22) Filed: Apr. 4, 2002

(51) Int. Cl. G06F 1/26

(52) U.S. Cl. 713/300

(57) ABSTRACT

There is provided a method for suspending an automatic shutdown of a hand-held device. The automatic shutdown results after a pre-specified time period of inactivity of the hand-held device. The method includes the step of receiving a user input to suspend the automatic shutdown. The automatic shutdown is disabled in response to the user input, such that the hand-held device is shutdown only if a user of the hand-held device manually shuts down the handheld device. The automatic shutdown is automatically re-enabled to occur after the pre-specified time period of inactivity, upon a subsequent power-up of the hand-held device.

### BACKGROUND OF THE INVENTION

1.FIELD OF THE INVENTION

The present invention generally relates to hand-held devices and, more particularly, to the temporary user suspension of the automatic shutdown feature (auto-off) provided for most hand-held devices.

2.BACKGROUND OF THE INVENTION

Most hand-held devices (e.g., personal digital assistants (PDAs), cellular phones, and so forth) include an “automatic shutdown” feature, which is also referred to as an “auto-off” feature.

FIG. 1 is a diagram illustrating an auto-off settings screen 100 of a handheld device, according to the prior art. The auto-off settings screen 100 is typically used to set up the auto-off feature, including options for setting up separate auto-off time-delays for when the unit is relying on battery power 110 and for when the unit is connected to an external power source 120. The auto-off setting screen 100 generally includes a power graph 130 that depicts the remaining power. Such a feature is typically seen in PDAs, Ebooks, lap-top computers, and other hand-held devices.

Some auto-off features allow the user to permanently disable the feature, so that the hand-held device will never turn itself off after a period of inactivity. Other auto-off features allow the user to set the auto-off time-delay to a long period of time so that the unit will wait quite some time before shutting down from inactivity. Neither of these solutions is desirable to the user who would normally want to utilize the auto-off feature to avoid battery drain, but wants a temporary suspension of the auto-off feature so that he or she can complete a task that requires him or her to reference the handheld device without actually manipulating any controls to reset the time delay of the auto-off. Permanently disabling the auto-off feature or setting the time delay to an extended period of time is undesirable, because both require the user to access the settings of the device to change the power settings back once he or she is finished with the current task, or risk draining the battery at a later time.

Accordingly, it would be desirable and highly advantageous to have an auto-off feature for a hand-held device, wherein the auto-off feature can be temporarily disabled by a user of the hand-held device but is re-enabled upon a subsequent power-up.

### 3.SUMMARY OF THE INVENTION

The problems stated above, as well as other related problems of the prior art, are solved by the present invention, which is directed to the temporary user suspension of the automatic shutdown (auto-off) feature provided for most handheld devices. The temporary user suspension temporarily disables the auto-off feature such that the hand-held device user has to manually shutdown the handheld device, thereby controlling the time at which the hand-held device is powered down. However, upon a subsequent power-up of the hand-held device, the autooff feature is automatically re-enabled.

According to an aspect of the present invention, there is provided a method for suspending an automatic shutdown of a hand-held device. The automatic shutdown results after a pre-specified time period of inactivity of the hand-held device. The method includes the step of receiving a user input to suspend the automatic shutdown. The automatic shutdown is disabled in response to the user input, such that the hand-held device is shutdown only if a user of the hand-held device manually shuts down the hand-held device. The automatic shutdown is automatically re-enabled to occur after the pre-specified time period of inactivity, upon a subsequent power-up of the hand-held device.

According to another aspect of the present invention, there is provided an automatic shutdown device for automatically shutting down a hand-held device. An input module receives a user input corresponding to a suspension of the automatic shutdown. A power control module engages in a first mode of operation when the user input is not received and engages in a second mode of operation when the user input is received. The first mode of operation is for performing an automatic shut down of the hand-held device after a pre-specified time period of inactivity. The second mode of operation is for suspending the automatic shutdown without regard to the pre-specified time period of inactivity, shutting down the hand-held device only if a manual shut down input is received from a user of the hand-held device, and automatically re-enabling the automatic shutdown to occur upon a subsequent power-up of the hand-held device and after the pre-specified time period of inactivity.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a diagram illustrating an auto-off settings screen of a hand-held device, according to the prior art;

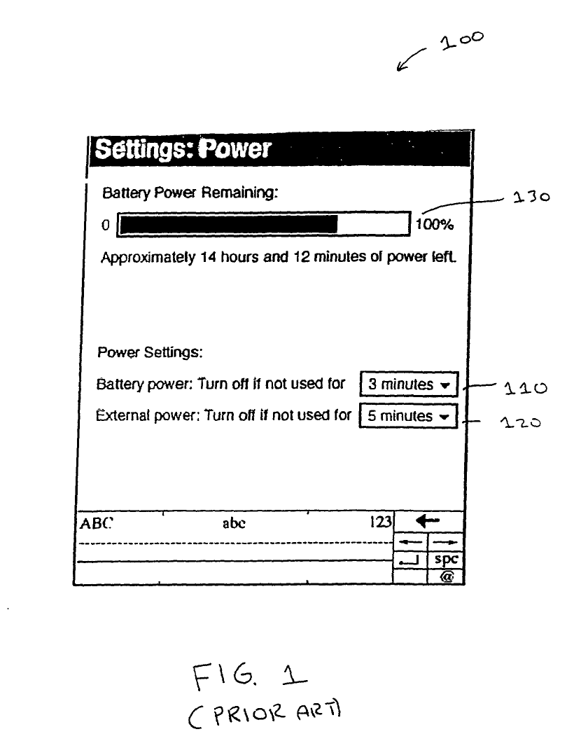

FIG. 2 is a block diagram illustrating a hand-held device 200 to which the present invention may be applied, according to an illustrative embodiment of the present invention;

FIG. 3 is a block diagram illustrating an automatic shutdown device 300 for a hand-held device, according to an illustrative embodiment of the present invention; and

FIG. 4 is a flow diagram illustrating a method for using a hand-held device having an auto-off feature that is capable of being temporarily suspended by a user of the hand-held device, according to an illustrative embodiment of the present invention.

### DETAILED DESCRIPTION OF THE INVENTION

The present invention is directed to the temporary user suspension of the automatic shutdown (auto-off) feature provided for most hand-held devices. The temporary user suspension temporarily disables the auto-off feature such that the user has to manually shutdown the hand-held device, thereby controlling the time at which the hand-held device is powered down. However, upon a subsequent power-up of the hand-held device, the auto-off feature is automatically re-enabled. Thus, the hand-held device user can continue whatever activity they were engaged in without having to reset the time-delay for the auto-off feature.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) that is executed via the operating system. In addition, various other peripheral devices may be connected to the computer platform such as an additional data storage device and a printing device.

It is to be further understood that, because some of the constituent system components and method steps depicted in the accompanying Figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

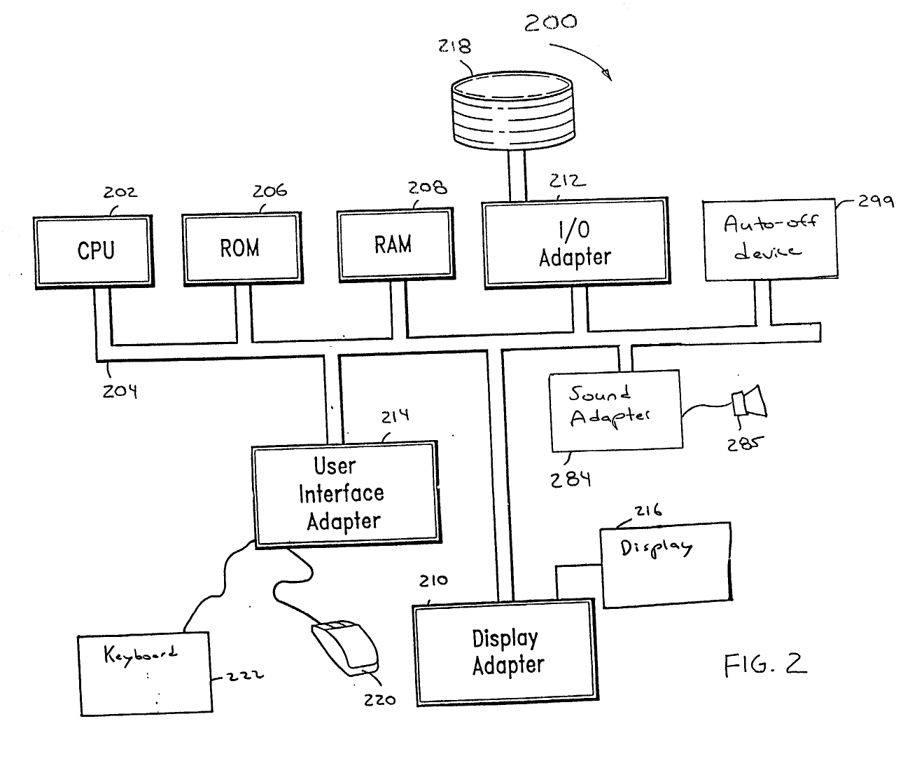

FIG. 2 is a block diagram illustrating a hand-held device 200 to which the present invention may be applied, according to an illustrative embodiment of the present invention. The hand-held device 200 includes at least one processor (CPU) 202 operatively coupled to other components via a system bus 204. A read only memory (ROM) 206, a random access memory (RAM) 208, a display adapter 210, an I/O adapter 212, a user interface adapter 214, and a sound adapter 284 are operatively coupled to the system bus 204.

A display device 216 is operatively coupled to system bus 204 by display adapter 210. A disk storage device (e.g., a magnetic or optical disk storage device) 218 is operatively coupled to system bus 204 by I/O adapter 212.

A mouse 220 and keyboard 222 are operatively coupled to system bus 204 by user interface adapter 214. The mouse 220 and keyboard 222 are used to input and output information to and from system 200.

At least one speaker (hereinafter “speaker”) 285 is operatively coupled to system bus 204 by sound adapter 284.

The hand-held device 200 further includes an auto-off device 299.

It is to be appreciated that the preceding elements of the hand-held device 200 are merely illustrative and the present invention may be applied to a handheld device having all or less than all of the preceding elements as well as other elements not shown herein. That is, given the teachings of the present invention provided herein, one of ordinary skill in the related art will contemplate these and various other configurations of the hand-held device 200 of FIG. 2, while maintaining the spirit and scope of the present invention.

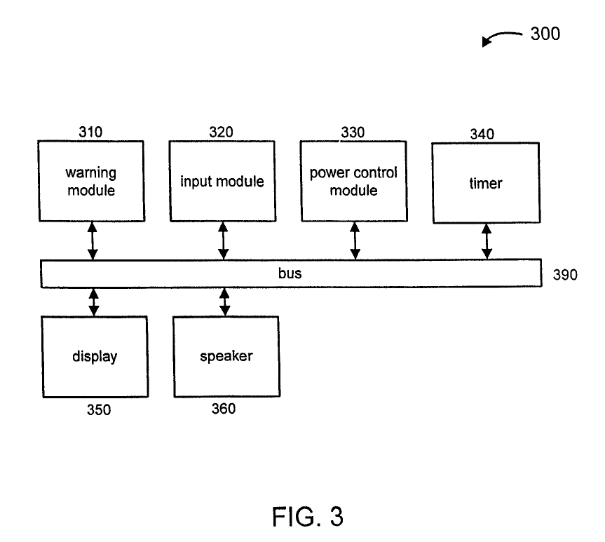

FIG. 3 is a block diagram illustrating an automatic shutdown device 300 for a hand-held device, according to an illustrative embodiment of the present invention. The automatic shutdown device 300 includes a warning module 310, an input module 320, a power control module 330, a timer 340, a display 350, and at least one speaker (hereinafter “speaker”360), all interconnected by a bus 390. The timer 340 performs timing functions. The warning module 310 provides a warning that an automatic shutdown of the hand-held device is to occur in a predesignated time period (e.g., 1 minute, etc.). The display 350 at least displays the warning, when the warning includes a visual warning. The speaker 360 audibly reproduces the warning, when the warning includes an audible warning. The input module 320 receives a user input corresponding to a suspension of the automatic shutdown. The power control module 330 performs an automatic shut down of the hand-held device after a pre-specified time period of inactivity. Moreover, the power control module 330 temporarily disables the automatic shutdown in response to the user input such that the hand-held device is shutdown only if the user manually shuts down the hand-held device; however, the power control module 330 re-enables the automatic shutdown to occur after the pre-specified time period of inactivity, upon a subsequent power-up of the hand-held device.

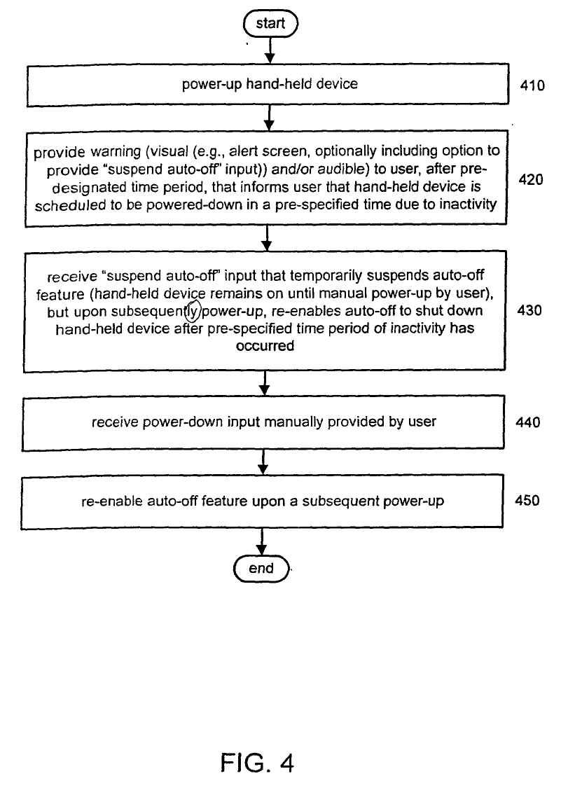

FIG. 4 is a flow diagram illustrating a method for using a hand-held device having an auto-off feature that is capable of being temporarily suspended by a user of the hand-held device, according to an illustrative embodiment of the present invention.

The hand-held device is powered-up (step 410). After a pre-designated time period, a warning is provided to the hand-held device user that informs the hand-held device user that the hand-held device is scheduled to be powereddown in a pre-specified time (e.g., 1 minute, imminent, and so forth) due to inactivity (step 420). A pre-specified time period for the inactivity may be factory pre-set and/or set/overridden by the user of the hand-held device. The warning may include a visual warning provided to the user via a display and/or an audible warning provided to the user via one or more speakers. In a preferred embodiment of the present invention, the warning includes at least a visual warning depicted as an alert screen that is displayed on the hand-held device. Moreover, it is preferable that the alert screen includes an option to temporarily suspend the auto-off feature (e.g., suspend auto-off input).

A “suspend auto-off” input is received that temporarily suspends the autooff feature (step 430). That is, the “suspend auto-off” input instructs the hand-held device to remain active and not shut itself off. Moreover, the “suspend auto-off” instructs the hand-held device to re-enable the auto-off feature to automatically shut down the hand-held device after the pre-specified time period of inactivity, upon a subsequent power-up of the hand-held device. Accordingly, the hand-held device user can continue whatever activity they were engaged in without having to reset the time-delay for the auto-off feature. Instead, when the hand-held device user is finished with the activity for which the auto-off was suspended, a powerdown input is manually provided by the hand-held device user to manually shut down the hand-held device (step 440).

Upon a subsequent power-up of the hand-held device, the auto-off feature is re-enabled (step 450). By re-enabling the auto-off feature, the hand-held device will automatically shut down if the pre-specified time period of inactivity occurs and the user input has not been provided by the user since the time the auto-off feature was re-enabled at step 450.

For the purposes of the present invention, the times when the user input has not been received and the hand-held device is allowed to automatically shut down after the pre-specified time period of inactivity can be considered to be a first mode of operation and the times when the user input has been received and the auto-off has been temporarily suspended can be considered to be a second mode of operation. The present invention allows a hand-held device to readily change from the first mode of operation to the second mode of operation by simply providing the user input.

Although the illustrative embodiments have been described herein with reference to the accompanying drawings, it is to be understood that the present invention is not limited to those precise embodiments, and that various other changes and modifications may be affected therein by one skilled in the art without departing from the scope or spirit of the invention. All such changes and modifications are intended to be included within the scope of the invention as defined by the appended claims.

What is claimed is:

1. A method for suspending an automatic shutdown of a hand-held device, the automatic shutdown resulting after a pre-specified time period of inactivity of the hand-held device, the method comprising the steps of:
receiving a user input to suspend the automatic shutdown;
disabling the automatic shutdown in response to the user input, such that the hand-held device is shutdown only if a user of the hand-held device manually shuts down the hand-held device; and
automatically re-enabling the automatic shutdown to occur after the prespecified time period of inactivity, upon a subsequent power-up of the hand-held device.

2. The method of claim 1, further comprising the step of providing a warning that the automatic shutdown is imminent, at a pre-designated time prior to the automatic shutdown.

3. The method of claim 2, wherein the warning is a visual warning.

4. The method of claim 3, wherein said providing step comprises the step of displaying the visual warning in a warning screen that includes an option to provide the user input.

5. The method of claim 2, wherein the warning is an audible warning.

6. The method of claim 5, wherein said providing step comprises the step of audibly reproducing the audible warning.

7. A method for suspending an automatic shutdown of a hand-held device, the automatic shutdown resulting after a pre-specified time period of inactivity of the hand-held device, the method comprising the steps of:
displaying an alert screen that alerts a user of the hand-held device that the automatic shutdown is to occur in a pre-designated time period and that includes an option for providing a user input to suspend the automatic shutdown;
receiving the user input;
disabling the automatic shutdown in response to the user input and without regard to the pre-specified time period of inactivity;
shutting down the hand-held device only if a manual shut down input is received from the user; and
automatically re-enabling the automatic shutdown to occur after the prespecified time period of inactivity, upon a subsequent power-up of the hand-held device.

8. The method of claim 7, further comprising the step of providing an audible warning to the user along with said displaying step.

9. An automatic shutdown device for automatically shutting down a hand-held device, comprising:
an input module for receiving a user input corresponding to a suspension of the automatic shutdown; and
a power control module for engaging in a first mode of operation when the user input is not received and for engaging in a second mode of operation when the user input is received, the first mode of operation for performing an automatic shut down of the hand-held device after a pre-specified time period of inactivity, the second mode of operation for suspending the automatic shutdown without regard to the pre-specified time period of inactivity, shutting down the hand-held device only if a manual shut down input is received from a user of the hand-held device, and automatically re-enabling the automatic shutdown to occur upon a subsequent power-up of the hand-held device and after the pre-specified time period of inactivity.

10. The automatic shutdown device of claim 9, further comprising a warning module for providing a warning that an automatic shutdown of the handheld device is to occur in a pre-designated time period, when the user input is not received and the pre-specified time period of inactivity is to elapse at the expiration of the pre-designated time period.

11. The automatic shutdown device of claim 10, wherein the warning is a visual warning, and said automatic shutdown device further comprises a display for receiving the warning from the warning module and for displaying the warning.

12. The automatic shutdown device of claim 11, wherein the display further displays an option to provide the user input concurrently with the display of the visual warning.

13. The automatic shutdown device of claim 10, wherein the warning is an audible warning, and said automatic shutdown device further comprises at least one speaker for audibly reproducing the audible alarm.

14. The automatic shutdown device of claim 10, wherein the warning includes at least one of a visual warning and an audible warning, and said automatic shutdown device further comprises at least one of a display for displaying the visual warning and at least one speaker for audibly reproducing the audible warning.

15. The automatic shutdown device of claim 14, wherein the visual warning and the audible warning are both provided to the user.
